(19) United States
(12) Patent Application Publication
(10) Pub. No.: US 2012/0325059 A1
(43) Pub. Date: Dec. 27, 2012

(54) Quasi open-end wrench

(76) Inventor: Alan Hamilton Swing, Shady Side, MD (US)

(21) Appl. No.: 13/135,010

(22) Filed: Jun. 23, 2011

(51) Int. Cl. B25B 13/08

(52) U.S. Cl. 81/125.1

(57) ABSTRACT

An open end wrench having a shank with a smooth planar side, the length of the shank, that functions as a torqueing jaw of opposed wrench heads formed at opposite ends of said shank.

The opposing wrench heads are each defined by two jaws, one of which is the smooth planar surface of the shank, and an arcuate throat interconnecting the jaws.

### REFERENCES CITED

U.S. PATENT DOCUMENTS

| | | |
|---|---|---|
| 5,148,726 | September 1992 | Huevschen |
| 6,009,778 | January 2000 | Hsieh |
| 5,307,713 | May 1994 | White |
| 5,172,614 | December 1992 | Monnet |
| 1,793,714 | April 1928 | E. Newberg |
| 3,447,405 | September 1967 | Lennon Et Al |
| 1,626,809 | December 1925 | Gillett |
| 2,652,735 | March 1949 | Wilder |
| 3,850,057 | November 1974 | Evans |
| 3,881,377 | May 1975 | Evans |
| 3,921,476 | November 1975 | Evans |

### BACKGROUND OF THE INVENTION

This invention relates to open-end wrenches and particular a wrench with a shank and wrenching heads on both ends of the shank, and the tendency of said wrench to slip off, and/or round polygonal fasteners when torque is applied. More specific, the heads of a typical open-end wrench consist of two planar jaws and a arcuate throat interconnecting the jaws which engage opposite/flat sides of a polygonal fastener. When a significant amount of torque is applied to overcome the resistance of the polygonal fastener, the jaws, with no means to restrain their given relative position, tend to spread apart and slip off/round the fastener.

There have been many attempts to remedy this condition as attested by the listed prier arts. However, none have incorporated the shank of the wrench as the torqueing jaw of the wrenching head as does the present invention.

### SUMMARY OF INVENTION

The universal object of the present invention is to disclose an open-end wrench, having a shank with a smooth planar side that functions as an integral part of the wrench heads at opposite ends of said shank. Each head has a backup jaw with a planar surface the same length as the distance from point to point of a given fastener. The torqueing jaw is the planar surface of the shank that extends into both heads terminating at bend reliefs, which are machined at the intersection of the arcute throats and the shank's smooth planar surface. The machined bend reliefs give the shank/torqueing jaw a flexible quality, whereupon, when torque is applied the distance between gripping jaws is shortened by skewing, thereby tightening the grip on the fastener. The type and size of the relief is determined by the material used.

With the mouths of the wrench heads facing each other, the appearance of opposing hooks can be envisioned.

### BRIEF DESCRIPTION OF THE DRAWINGS

FIG. 1 is a perspective view of an open-end wrench according to the invention;

FIG. 2 is a view of the wrench showing location of section 2A;

FIG. 2A is the section called out in FIG. 2;

FIG. 3 and FIG. 4 are partial views showing correct application of wrench in accordance with the invention;

FIG. 5 shows application of wrench in accordance with the invention therein;

### DETAILED DESCRIPTION OF THE PREFERRED EMBODIMENT

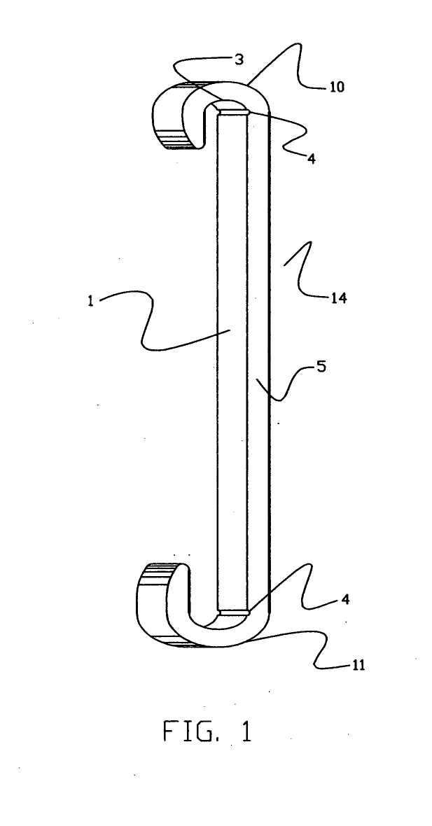

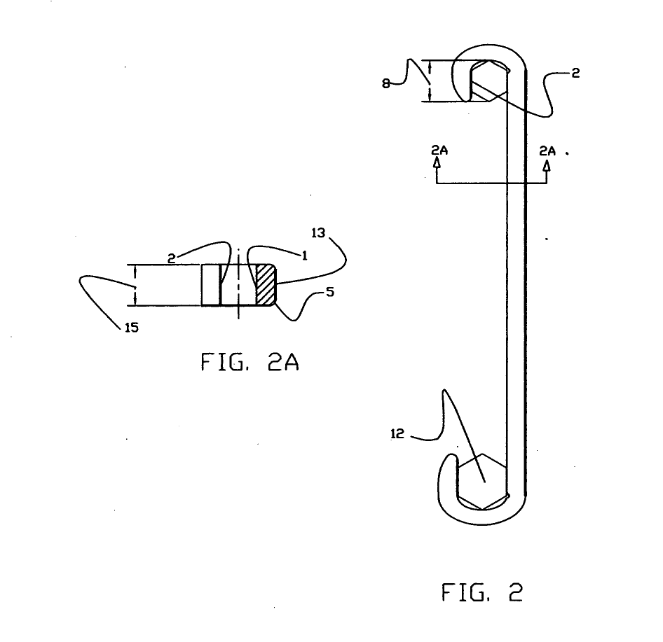

The preferred embodiment of the present invention is defined by FIGS. 1 through 5. FIG. 1 illustrates an open-end wrench 14, having a shank 5, with a smooth planar surface 1, which is the torqueing jaw of wrench heads 10, and 11. The bend relief 4 is machined at the intersection of the arcuate throat 3 and the planar surface 1. Shown in FIG. 2 is the length 8, of jaw 2, and the location/direction of section 2A. Included is the reference of hexagonal fastener 12.

Refereeing now to FIG. 2A showing extraordinary thickness 15, of planar surface 1, planar surface 2, and like thickness of surface 13, which adds comfort to the palm of the user.

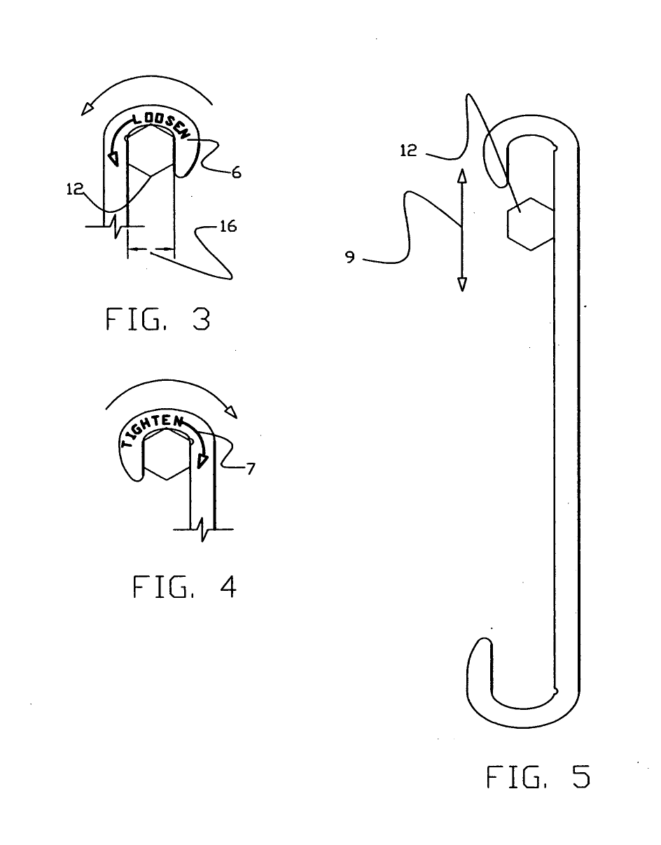

To implement the flexible quality of shank 5, FIG. 3, and FIG. 4, show the engraved, direction to “loosen” 6, or “tighten” 7, polygonal fastener 12.

When force is applied to shank 5, the resulting torque is at bend relief 4, whereupon the distance 16, between gripping jaws 1 and 2 is shortened by skewing, thus tightening the grip on the fastener. For this purpose, FIG. 5 pictorial demonstrates 9, how to engage and disengage the present invention with a polygonal fastener 12.

What is claimed is:

1. A one piece open-end wrench having a shank with a smooth planar side, that extends into the heads at opposite ends of said shank, and is terminated at the intersection of the shank and the arcuate throats of opposing heads.

2. A one piece open-end wrench of claim 1, wherein, the shank of the wrench is made flexible by means of bend reliefs.

3. A one piece open-end wrench of claim 1, wherein, said wrench has a means for identifying proper usage.
